(19) United States
(12) Patent Application Publication
(10) Pub. No.: US 2010/0084207 A1
(43) Pub. Date: Apr. 8, 2010

(54) CONTROLLERLESS ELECTRIC DRIVE SYSTEM

(76) Inventor: John C. Wyall, Orem, UT (US)

Correspondence Address: Workman Nydegger;1000 Eagle Gate Tower, 60 East South Temple, Salt Lake City, UT, 84111, US

(21) Appl. No.: 12/618,247

(22) Filed: Nov. 13, 2009

Related U.S. Application Data
(63) Continuation-in-part of application No. 12/437,959, filed on May 8, 2009.
(60) Provisional application No. 61/052,112, filed on May 9, 2008.
(60) Provisional application No. 61/127,649, filed on May 14, 2008.
(60) Provisional application No. 61/055,756, filed on May 23, 2008.

(51) Int. Cl. B60K 6/42; B60K 1/00; G06F 19/00

(52) U.S. Cl. 180/65.22; 180/65.7; 701/22; 180/65.21

(57) ABSTRACT

Embodiments described herein are directed to a controllerless electric drive system, a controllerless hybrid drive system and a method for controlling drive system characteristics based on received drive system inputs. In one instance, a controllerless electric drive system is configured to power one or more powered wheels. The controllerless electric drive system includes a battery, a substantially constant-speed electric motor, a torque converter/clutch, a continuously variable transmission and one or more powered wheels. The battery is coupled to the substantially constant-speed electric motor, and the motor is coupled to the continuously variable transmission via the torque converter. As such, the battery provides power for the electric motor to drive the continuously variable transmission which turns the one or more powered wheels, without implementing a controller to vary the current or voltage between the battery and the motor.

### RELATED APPLICATIONS

This application claims the benefit of and is a continuation in part of U.S. patent application Ser. No. 12/437,959, filed on May 8, 2009, which is incorporated by reference herein and which claims the benefit of U.S. Provisional Application No. 61/052,112 entitled “Controllerless Electric Drive System”, filed on May 9, 2008, U.S. Provisional Application No. 61/127,649 entitled “Controllerless Hybrid Drive System”, filed on May 14, 2008 and U.S. Provisional Application No. 61/055,756 entitled “IVT Controller”, filed on May 23, 2008, each of which is incorporated by reference herein.

### BACKGROUND

Automobiles have been commonplace items in our society for many years. Internal combustion engines have long been the power source that drives these automobiles. Other power sources including electric and hybrid electric systems are gradually coming into the mainstream. Today, the technology for electric and hybrid vehicles has developed enough to allow limited production of these vehicles for sale in the marketplace. Currently, however, all electric and hybrid vehicles use an electronic controller to operate. Because these controllers are inherently expensive, electric and hybrid vehicles typically cannot be produced cheaply enough to be widely available.

Modern all-electric cars have four main components: a battery 110, a controller 120, a motor 130, and either a gear box 140 or a transmission (see Prior Art FIG. 1) (other car components, with the exception of wheels 150, are not shown). There is no fuel-burning component in such all-electric vehicles. All-electric cars are typically configured with a battery connected to a controller, with the controller connected to an electric motor. The electric motor is connected to a gear box or transmission, which is, in turn, connected to the driving wheels.

Today's hybrid cars generally incorporate the same components as the all-electric cars (i.e. battery, controller, motor and transmission), with the addition of an internal combustion engine (ICE). Hybrid cars are typically configured in one of two ways: parallel hybrid or serial hybrid.

The parallel hybrid configuration (see Prior Art FIG. 2) is often the preferred choice of the large manufacturers such as Toyota™, Ford™, and Honda™. The parallel hybrid uses an ICE 205, connected to the electric motor 230 by a clutch 206. Together, the electric motor and the engine supply the wheels 250 (via continuously variable transmission (CVT) 240C) with enough power to handle higher loads, such as accelerating or going up hills. The large manufacturers tend to prefer the parallel hybrid because the extra power from the engine allows them to use a smaller battery 210 and motor 230 and hence, a smaller, cheaper controller 220. However, a change in the engine's rpm or in the load it is under causes the engine to run at less than its peak efficiency. This loss of efficiency causes the car to have a shorter mileage range and lower energy savings than expected by most consumers, especially when considering the additional money they would pay to purchase such a hybrid vehicle.

Serial hybrids, while less common than parallel hybrids, are typically more efficient than parallel hybrids. In a serial hybrid, the ICE is connected to a generator 307 whose sole function is to charge the battery pack 310 (see Prior Art FIG. 3). The engine 305 is not used to mechanically drive the car; rather, it merely drives the generator to charge the battery. The battery, in turn, drives the electric motor 330, as directed by a controller 320. This, however, necessitates a larger motor than that used in a parallel hybrid and a bigger and more expensive controller to handle the motor. Because the engine is not mechanically connected to the wheels 350, the motor has to be of sufficient size to drive the wheels by itself (via gear box 340X). Thus, while some efficiency advantages may be obtained because the onboard engine can maintain a substantially constant rpm or load, the higher costs for these components pushes the price for such vehicles out of reach of most consumers.

Transmission choice in any type of car, be it all-electric, parallel hybrid, serial hybrid or conventional ICE, is highly important. All-electric cars generally use a gear box. As an example, the EV1 by General Motors™ used an alternating current (AC) induction motor with a 10:1 gear reduction, which runs at 10,000 rpm at top speed.

Both parallel and serial hybrids, because of the fuel-burning engine, use a transmission (as opposed to a gear box) to optimize the torque characteristic of the engine. Many hybrids on the market today use a continuously variable transmission (CVT) which allows the car to best optimize the torque characteristics of the engine and the motor. With a CVT, the main motor comes to a complete stop each time the wheels stop turning, thus requiring a controller to start the motor up upon receiving an acceleration input.

Electric motors used in production hybrids today are usually either AC induction or direct current (DC) brushless. The advantages of the brushless DC motor over the AC induction motor are that it can be smaller in size for the same power output and be highly efficient. On the flipside, the AC induction motor tends to be more rugged and cheaper to manufacture than the DC brushless motor. Because batteries cannot produce the sine wave necessary to make these electric motors spin, connecting the battery directly to these types of motors will not spin the motor and will cause the motor to overheat and burn up. A controller is needed to take the voltage and current from the battery and create the proper sine wave to start the motor and allow it to meet the specified torque and rpm of the car under varying loads and conditions.

This, in general, is a very complex process. Only newer, more modern controllers have been able to handle the larger, more powerful motor used to propel a full-size car down the road. Automobile controllers typically use power electronics such as metal-oxide-semiconductor field-effect transistors (MOSFETs) or insulated-gate bipolar transistors (IGBTs) to drive the motors. These types of power electronics are relatively expensive and contribute to the increased cost of hybrid vehicles. Because most individual power electronics can only handle a small amount of current, many are combined to work in parallel in order to handle the higher current necessary to move the automobile.

Because this package of power electronics is expensive and does not handle high currents very well, the designers of hybrid controllers often prefer to use high voltage and low current, thus getting by with fewer MOSFETs or IGBTs, and thus lowering costs to a degree. The high voltage, however, can be a lethal threat to service technicians and to occupants in a vehicle should it be involved in an accident. An example is the 2007 Toyota™ Camry hybrid which includes a 105 KW motor and controller that operates at 244.8 volts and 430 amps. Even with the high-voltage, low-amperage trade-off, this controller is still expensive because it uses a large number of IGBTs.

Once the horsepower, or wattage, requirement has been set and the size of the motor has been chosen, the wattage requirement can be met by a high-voltage/low current combination, a low-voltage/high-current combination or anything in between. The way the controller is built determines what the voltage/amperage combination will be.

It is possible with today's technology to make a safe electric or hybrid vehicle that uses low voltage and high amperage to drive the vehicle and meet consumers' expectations for performance. However, to meet these expectations, significantly more additional power electronics components would be used, thus driving up costs significantly and making these vehicles unaffordable for considerably more consumers. This is why manufacturers have generally opted for the cheaper high-voltage/low-current design.

High voltage batteries are difficult to manage because of the high number of cells required to achieve the needed voltage. Regardless which type of battery is chosen, the chemistry (not the size of the cell itself) determines the voltage output of the cell. For example, typical nickel metal hydride cells have only 1.2 volts, irrespective of size; but a larger cell will last longer than a smaller cell. In order to reach high voltage, the battery would need a high number of individual cells hooked together in series.

Because of a variety of factors, the cells in a battery typically do not all work equally well, and if one cell goes bad, the battery may be damaged, sometimes beyond use. The more cells in a battery, the more difficult it is to manage and maintain. Conversely, the fewer cells in a battery, the easier the battery is to manage and maintain.

The choice that manufacturers have made to use a cheaper controller not only makes the battery more expensive and less reliable, but it also makes it unsafe. The voltage safety threshold for an unshielded human is about 60 volts. A person could receive a shock from a 60-volt system and survive. A shock from a 120-volt system could kill a person. A shock from a 244.8-volt nickel-metal hydride battery pack used in a hybrid car could kill or seriously impair a person. However, because a high-voltage/low-current controller is cheaper to build, this risk is considered to be acceptable.

Current drive systems are designed with flexibility in order to vary the rotational speed of the wheels, and vary the torque to match the demand. Similarly, when torque demand goes up or down based on terrain or acceleration/deceleration inputs, the torque is varied to meet demand. One notable drawback, however, is the inefficiency of the ICE when varying the rpm in conjunction with the varying torque. This inefficiency, along with the current focus on higher fuel mileage, has designers looking to the electric motor because it is more efficient at all torque levels and rpm when compared to the ICE.

Another drawback is the inability of the ICE system to recuperate the kinetic energy from the rolling car. Recuperating the kinetic energy and storing it for future use is called regenerative braking. In the all-electric and the hybrid cars, the controller uses a complex algorithm to use the motor as a generator, thus making the car slow down while generating electricity to charge up the battery. These controllers, as mentioned above, however, are expensive and add a substantial level of complexity to the all-electric and hybrid drive systems.

### BRIEF SUMMARY

Embodiments described herein are directed to a controllerless electric drive system, a controllerless hybrid drive system and a method for controlling drive system characteristics based on received drive system inputs. One embodiment describes a controllerless electric drive system configured to power one or more powered wheels. The controllerless electric drive system includes a battery, a substantially constant-speed electric motor, a torque converter or a clutch, a continuously variable transmission and one or more powered wheels. The battery is coupled to the substantially constant-speed electric motor, and the motor is coupled to the continuously variable transmission via the torque converter or clutch. As such, the battery provides power for the electric motor to drive the continuously variable transmission which turns the one or more powered wheels, without implementing a controller to vary the current between the battery and the motor.

Another embodiment describes a controllerless hybrid drive system that includes a battery, a substantially constant-speed electric motor, an engine, a clutch, a torque converter/clutch, a continuously variable transmission, and one or more powered wheels. The battery is coupled to the substantially constant-speed electric motor, and the engine is coupled to the motor through the clutch. The substantially constant-speed electric motor is coupled to the continuously variable transmission via the torque converter/clutch, so that both the battery and the engine provide power for the electric motor to drive the continuously variable transmission which turns the powered wheels, without implementing a controller to vary the current between the battery and the motor.

In another embodiment, a computer system performs a method for controlling drive system characteristics based on one or more received drive system inputs. The computer system receives inputs from a vehicle user indicating that the acceleration rate or the deceleration rate is to be adjusted. The acceleration and deceleration rates are adjustable using an actuator configured to vary the rpm of the output shaft of the CVT. The computer system determines, based on the received inputs, the degree to which the acceleration rate or the deceleration rate is to be adjusted. The computer system also adjusts the acceleration rate or the deceleration rate by varying the rpm of the output shaft of the CVT using the actuator.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

To further clarify the above and other advantages and features of embodiments of the present invention, a more particular description of embodiments of the present invention will be rendered by reference to the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates an electric drive system architecture.

FIG. 2 illustrates a parallel hybrid drive system architecture.

FIG. 3 illustrates a serial hybrid drive system architecture.

FIG. 4 illustrates a controllerless electric drive system architecture.

FIG. 5 illustrates a controllerless hybrid drive system architecture.

FIG. 6 illustrates an alternative embodiment of a controllerless drive system.

FIG. 7 illustrates an alternative embodiment of a controllerless hybrid drive system.

FIG. 8 illustrates another alternative embodiment of a controllerless hybrid drive system.

FIG. 9 illustrates another alternative embodiment of a controllerless hybrid drive system.

FIG. 10 illustrates another alternative embodiment of a controllerless hybrid drive system.

FIG. 11 illustrates a flowchart of an example method for controlling drive system characteristics based on one or more received drive system inputs.

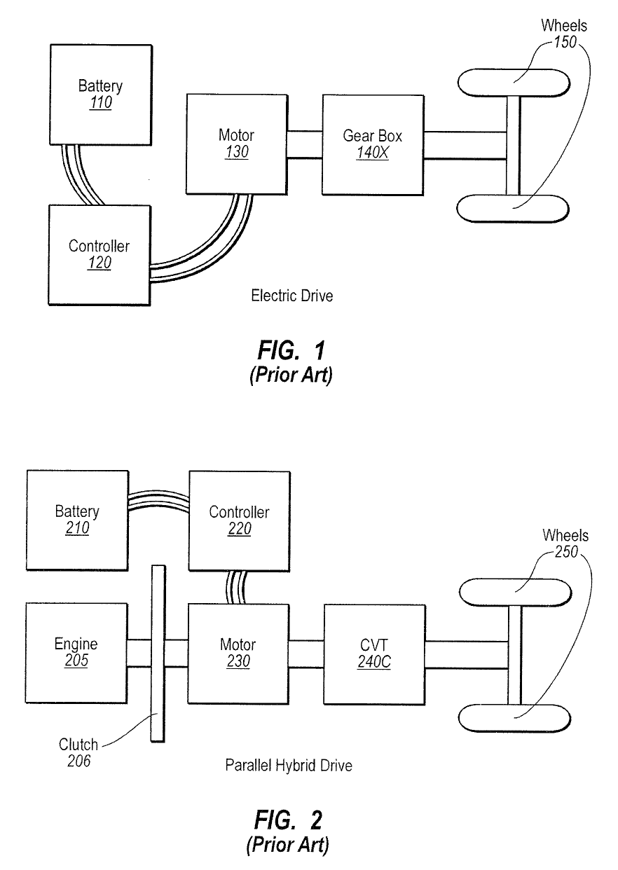

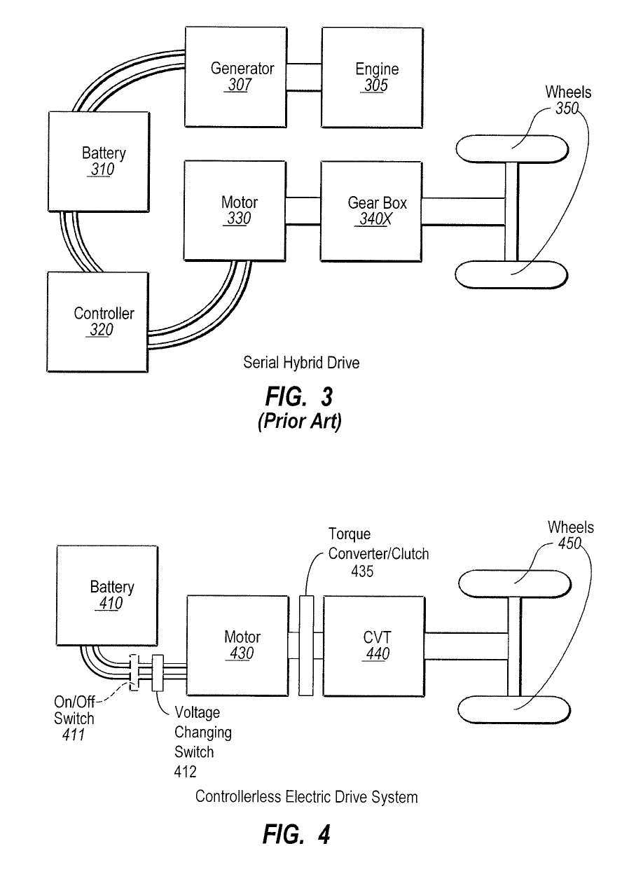

### DESCRIPTION

Embodiments described herein are directed to a controllerless electric drive system, a controllerless hybrid drive system and a method for controlling drive system characteristics based on received drive system inputs. One embodiment describes a controllerless electric drive system configured to power one or more powered wheels. The controllerless electric drive system includes a battery, a substantially constant-speed electric motor, a torque converter or clutch, a continuously variable transmission (CVT) and one or more powered wheels. The battery is coupled to the substantially constant-speed electric motor, and the motor is coupled to the continuously variable transmission via the torque converter/clutch. As such, the battery provides power for the electric motor to drive the continuously variable transmission which turns the one or more powered wheels, without implementing a controller to vary the current between the battery and the motor.

Another embodiment describes a controllerless hybrid drive system that includes a battery, a substantially constant-speed electric motor, an engine, a clutch, a torque converter/clutch, a continuously variable transmission, and one or more powered wheels. The battery is coupled to the substantially constant-speed electric motor, and the engine is coupled to the motor through the clutch. The substantially constant-speed electric motor is coupled to the continuously variable transmission via the torque converter/clutch, so that both the battery and the engine provide power for the electric motor to drive the continuously variable transmission which turns the powered wheels, without implementing a controller to vary the current and voltage between the battery and the motor.

In another embodiment, a computer system performs a method for controlling drive system characteristics based on one or more received drive system inputs. The computer system receives inputs from a vehicle user indicating that the acceleration rate or the deceleration rate is to be adjusted. The acceleration and deceleration rates are adjustable using an actuator configured to vary the rpm of the output shaft of the CVT. The computer system determines, based on the received inputs, the degree to which the acceleration rate or the deceleration rate is to be adjusted. The computer system also adjusts the acceleration rate or the deceleration rate by varying the rpm of the output shaft of the CVT using the actuator.

The following discussion now refers to a number of methods and method acts that may be performed. It should be noted, that although the method acts may be discussed in a certain order or illustrated in a flow chart as occurring in a particular order, no particular ordering is necessarily required unless specifically stated, or required because an act is dependent on another act being completed prior to the act being performed.

FIG. 4 illustrates a controllerless electric drive system architecture in which the principles of the present invention may be employed. In one embodiment, the controllerless electric drive system includes a battery 410, a voltage changing switch 412, an electric motor 430, a torque converter 435, a continuously variable transmission 440 and one or more powered wheels 450. The system may optionally include an on/off switch 411 positioned between the battery and the electric motor. The system may also optionally include a clutch instead of a torque converter placed between the motor and the CVT. Accordingly, this element will be referred to as a “torque converter/clutch” herein to indicate that the element can be either a torque converter or a clutch.

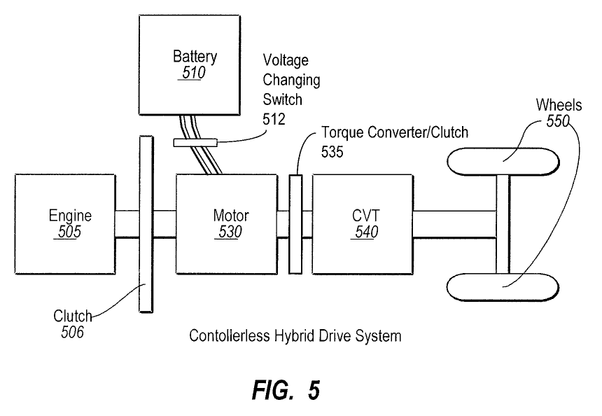

Each element of the controllerless electric drive system will be explained below with reference to FIGS. 4-10. It should be noted that, in the figures, like elements are numbered in like fashion. Accordingly, in one example, the electric motor is numbered 430 in FIGS. 4 and 530 in FIG. 5, and so on. However, at least in some embodiments, like numbers may not necessarily indicate that the element is the same as another element, or that one type of element cannot be replaced with another type of element or another element altogether.

As illustrated in FIG. 4, battery 410 may be connected directly to a substantially constant-speed electric motor 430 which, in turn, is connected to CVT 440. This design would not only eliminate the use of a controller (e.g. an IGBT) but also allow the designer to build the controllerless electric drive system (“drive system”) at a lower voltage. Such a drive system would allow a designer to use fewer battery cells, thus allowing for a more manageable battery pack. Moreover, the lower voltage would make it safer for the passengers in the car as well as technicians who work on the car.

The drive system's components include electric motor 430. Electric motor 430 may be a constant-speed motor, such as a shunt DC motor or a homopolar motor (also known as a Faraday disk motor). As used herein, the term “constant-speed motor” or “substantially constant-speed motor” refer to a motor that functions at a constant or substantially constant speed. It will be recognized that even in a constant-speed motor, minor speed fluctuations will occur. Accordingly, the term “constant-speed” should be read to include a reasonable amount of motor speed fluctuation. Constant-speed motors are designed to maintain a predetermined or equilibrium speed, even when temporarily diverted from such speed (e.g. when an increased or decreased load is placed on the motor). The characteristics of motor 430 will be explained in greater detail below.

The drive system's components further include continuously variable transmission (CVT) 440. CVT 440 may be connected to the motor 430 via torque converter/clutch 435. The torque converter may be any type of torque converter, including those conventionally used in automatic transmission vehicles. The torque converter may provide a hydraulic linkage between the motor and the CVT. This hydraulic linkage allows some slippage to occur between the motor and the CVT. This slippage, in turn, allows the motor to continue running at a constant speed.

Similar to the torque converter, clutch may be any type of clutch, including those conventionally used in manual transmission vehicles. The clutch also allows motor to continue running at a constant speed. The clutch may be incrementally applied so as to gradually transfer torque from the motor to the CVT.

Thus, the torque converter/clutch 435 can be used to take the car from idle (where the torque converter/clutch is not converting electric motor rotations into torque (or is doing so in a very limited manner)) and gradually apply torque as the driver presses the acceleration pedal. Eventually, when the vehicle has accelerated to a certain speed, the torque converter couples with the flywheel to form a solid connection between the engine and the transmission (e.g. CVT 440).

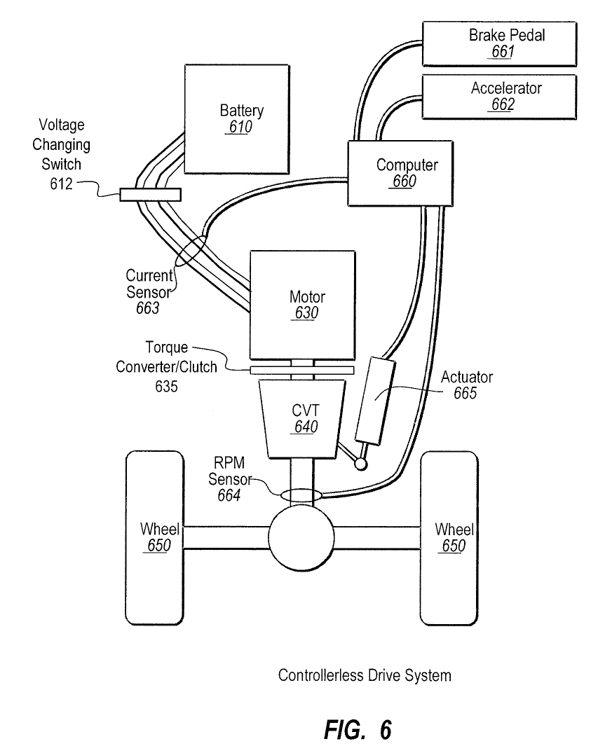

CVT 440 may include those transmissions capable of varying the applied torque to the driven wheels from zero pounds of force to the maximum amount of torque in fine (and in some cases infinite) increments, while the electric motor 430 is running and providing torque to the CVT. CVT 440 may be a geared or other belt-type continuously variable transmission. The amount of torque applied may be adjusted using actuator 665, as will be described in greater detail with reference to FIG. 6.

Battery 410 may be any type of battery or other device capable of storing electricity (e.g. a capacitor). Battery 410 may include dry cell, wet cell, electrolytic cell, fuel cell, flow cell, primary cell, secondary cell, or any other type of battery. Moreover, multiple batteries of varying types or of a single type may be used in combination to provide the desired voltage or amperage. In some embodiments, battery 410 may comprise a low-voltage battery pack.

Accordingly, as shown in FIG. 4, the battery 410 may be coupled to the electric motor 430, which in turn powers the CVT 440, which turns the wheels 450. In such a configuration, the use of a controller to vary the voltage/amperage between the battery and the electric motor is avoided, along with the controller's corresponding high priced power electronics such as MOSFETs and IGBTs.

In some cases, a voltage changing switch (412) or relay may be used to decrease the voltage flowing from the battery to the motor. This decrease in voltage leads to a decrease in the motor's rpm (but not a decrease in torque). A decreased rpm may be more efficient and better suited for use with torque converter/clutch 435. In one embodiment, battery 410 may be designed to provide 48 volts. Voltage changing switch 412 may reduce the voltage to the motor by half (i.e. to 24 volts). This decrease in voltage then reduces the motor's rpm's from 2000 rpm at 48V to 1000 rpm at 24V. The decreased rpm's would decrease the heat generated in the torque converter. Then, as the vehicle comes up to a certain speed, the voltage changing switch 412 could be switched to restore the full voltage to the motor (48V in this example). Upon receiving the full voltage from the battery, the motor would then return to its normal, full rpm (2000 rpm in this example).

It should be noted that the voltage change caused by a voltage switch may be accomplished by tapping into the battery at various different points depending on how many battery cells are to be activated. By tapping into or activating a certain number of battery cells, the motor can run off the battery at a determined set speed. Unlike a controller, the voltage switch can only increase or decrease the voltage by the amount of voltage of the individual cell of the battery. For example, the voltage switch can only increase the voltage by 2.2 volts for a lead acid battery and 1.2 volts for a nickel cadmium battery. The voltage changing switch does not regulate the current as a controller would (e.g. an IGBT or MOSFET).

In some embodiments, electric motor 430 may comprise a constant-speed shunt direct current (DC) motor. Shunt DC motors are commonly used and are notable for their excellent constant speed regulation. DC shunt motors are designed such that the motor's connecting field windings are positioned in parallel with the motor's armature. The voltage is determined by the gauge of wire used in the winding of the armature and the connecting field. The torque that the shunt DC motor can produce is in direct correlation to the current it can handle (e.g. from the battery). The output current is determined by the physical size of the shunt DC motor and the conductivity of the wire. Thus, shunt DC motors are designed to run at a predetermined rpm when directly connected to the battery. This occurs without going through a controller. As long as the voltage and current of the battery match the motor design, the motor will self-regulate at the designed speed.

Thus, for example, if the shunt motor is running at its designed speed and a load is put on the shaft, any back-electromotive force is reduced, which allows more current to pass through the motor. The additional current generates more torque and brings the motor back up to the designed equilibrium speed. Likewise, if the load is removed to some degree, the motor begins to speed up and the back-electromotive force is automatically increased. This automatically reverses the current, charges the battery and slows the motor down until it reaches the equilibrium point. Thus, in cases where a shunt motor is connected to an CVT, the shunt motor may maintain its equilibrium speed when a load is applied from the CVT. Moreover, as the load increases or decreases (e.g. when the vehicle is being driven), the shunt motor will dynamically adjust based on the changes to the back-electromotive force.

The battery 410 may be configured to start the electric shunt motor 430. In some configurations, an on/off switch 411 may be provided to manually or electronically start or stop the motor. In some embodiments, the controllerless electric drive system of FIG. 4 may be attached to and may comprise the drivetrain of an automobile. In one example, when the vehicle to which the drive system is attached is at zero speed (i.e. the vehicle is stopped), the motor is still running at the same constant speed. As the CVT 440 speeds up or slows down incrementally to induce forward (or reverse) motion, an increased load is placed on the shunt motor. This reduces back-electromotive force, which allows more current to pass from the battery to the motor. The increase in current creates more torque and brings the motor back up to the designed (equilibrium) speed. Similarly, when the CVT slows down decrementally to reduce forward (or reverse) acceleration, back-electromotive force is increased, which reverses the current and charges the battery. This reversal of current, in turn, puts a back torque on the shunt motor and brings it back to equilibrium. This process may occur in the same or a similar fashion when using a homopolar motor.

Homopolar motors or Faraday disks are true DC motors because they do not have any form of switching occurring inside the rotor or the stator. As will be understood by one skilled in the art, an electric current in a magnetic field experiences a force that is perpendicular to both its direction of movement and the magnetic field. In the homopolar motor, the electric current produced by the battery moves radially through the disk, which has a magnetic field along its longitudinal axis. The resulting Lorentz force in the tangential direction produces a torque in the disk. In contrast to other electrical motors, both the orientation and magnitude of the magnetic field and the electric current do not change. Like most electro-mechanical machines, a homopolar motor is reversible so that when electrical energy of a suitable kind is put into its terminals, mechanical energy can be obtained from its motion and vice versa. Thus, a homopolar motor can be used as a generator by rotating it faster than its equilibrium speed.

Like the shunt motor, the homopolar is self governing as to the rpm. It too can be connected directly to the battery 410 and maintain a constant rpm as long as the torque is kept within the range of the motor design. The homopolar motor may also be connected to the CVT as a main driver for a system that starts from a stand still and varies its speed and load. In some cases, the homopolar motor may be spinning the input shaft of the CVT at the motor's designed speed and the output shaft of the CVT may not be rotating. This configuration allows the motor to deliver its peak torque at the start-up of the car. As the CVT incrementally adds a load on the homopolar motor, more current is automatically withdrawn from the battery to maintain the motor's designed speed. Similarly, as the CVT incrementally reduces the load on the homopolar motor, less current is drawn from the battery, as the motor automatically maintains its design speed. In some cases, excess energy captured during deceleration may automatically be stored (e.g. using regenerative braking) without having to use a complex, expensive controller.

The motor 410 may include any type of electric motor, including constant-speed motors such as a DC shunt motor or a homopolar motor. The motor may be connected directly to the battery via wiring or some other type of connection capable of carrying current between the battery and the motor. In some cases, as explained above, the (substantially) constant-speed motor is designed to maintain an equilibrium speed which corresponds to a certain voltage and/or current. Thus, for a given equilibrium speed, a battery with the corresponding voltage/amperage should be supplied. DC shunt and homopolar motors characteristically maintain a certain rpm, and return to that rpm after being diverted from it (e.g. due to an increasing or decreasing load on the motor).

Thus, a vehicle or other machine may be driven by a controllerless drive system including a battery, a constant-speed motor and a continuously variable transmission. The controllerless drive system is comparatively cheaper to build (due to the lack of a controller), may have a higher fuel- and energy-efficiency; and may emit less pollution than a comparative electric or hybrid model.

In some embodiments, a controllerless hybrid drive system may be used to power a vehicle. For instance, as illustrated in FIG. 5, an internal combustion engine (ICE) 505 may be coupled to a constant-speed motor 530 such as a homopolar or a shunt motor via a clutch 506. The motor may, in turn, be connected to torque converter/clutch 535, which is then connected to CVT 540 which drives the wheels 550. Thus, in some embodiments, controllerless hybrid drive system of FIG. 5 may include two clutches where one clutch is placed between engine 505 and motor 530 and the other clutch is placed between motor 530 and CVT 540. Battery 510 is configured to drive the electric motor 530. As with voltage changing switch 412, voltage changing switch 512 can be used to reduce the voltage flowing to the motor. In some cases, a monitoring system may be attached to the battery to monitor the battery's voltage and other characteristics. In such a configuration, the use of a controller is avoided.

Because of the natural speed-governing behavior of the homopolar or shunt motor in the controllerless electric drive system (illustrated in FIG. 4), adding an ICE in addition to the electric motor provides various benefits. For example, the engine 505 may include a governor which may be set to run the engine at a higher rpm than the electric motor is designed to run. When more torque is required or when the battery 510 needs to be charged, the clutch 506 engages the engine to the motor and the engine is turned on in the process. The engine and the motor will then run at substantially the same rpm (which will automatically fluctuate within a limited range depending on torque requirements of the drive wheels). This is possible due to the nature of the CVT. Moreover, while the engine and the motor are running at substantially the same speed, the torque converter/clutch 535 allows the motor to spin at a different rpm than the CVT and gradually applies torque to the CVT as acceleration input is received from the user. Still further, it should be noted that a voltage changing switch 512 may be used within the controllerless hybrid drive system of FIG. 5 to reduce the amount of voltage flowing from the battery to the motor, thereby reducing the speed of the motor.

In some cases, a monitoring system (e.g. computer 660 in FIG. 6) may be used to check the state of charge of the battery. When the battery is fully charged, the monitoring system may be configured to turn off the engine and disengage the clutch. The monitoring system may also engage the engine when the battery has been discharged to a predetermined level. Such a hybrid drive system may be scalable and can be designed for everything from small vehicles to commercial semi-trucks to locomotives.

In some cases, efficient operation of the controllerless hybrid drive system may come as the result of the system's self-regulatory motor. In a typical configuration, either a homopolar motor or a shunt motor may be used. Other motors configured to maintain an equilibrium speed may be used in addition or as an alternative to shunt or homopolar motors. Because the constant-speed motor is designed to run at a specific rpm, the torque on the shaft can ether slow the motor down or speed it up.

When accelerating a vehicle, a demand for torque slows the motor down. As a result, the back-electromotive force is reduced, which allows more current to flow into the motor. This allows more torque to be produced and brings the rpms back up to the motor's designed speed. Conversely, if there is a torque placed on the motor which speeds up the shaft (such as during regenerative braking, or whenever the engine is set to run at an rpm higher than the motor's designed speed), the motor's back-electromotive force is increased, and the motor may work as a generator, feeding current to the battery. This production of current slows the motor down and regulates the speed automatically.

In one exemplary embodiment, the electric motor 530 is designed to run at 2000 rpm and the engine 505 is governed to run at 2500 rpm. Because the motor and engine are coupled together, their rpm will be the same but will fluctuate above or below the designated rpm of the motor.

If the torque at the wheels 550 is great enough to pull the rpm below the motor's designated rpm, all of the torque of the engine will be applied to the drive wheels. The motor may be designed to pull the necessary current from the battery to satisfy any additional power required by the drive wheels until the rpms come back to the designated 2000 rpm.

If, on the other hand, the required torque from the drive wheels is lower than the engine is producing, the rpm will automatically be higher than 2000 rpm (e.g. 2500) and the motor will, by its nature, become a generator and start charging up the battery. The flow of current to or from the motor/generator is dependent on the rpm of the motor/generator. In this example, if the rpm is under the design speed of 2000 rpm, the motor would function as a motor and drive the shaft. If the rpm is over 2000, the motor would function as a generator and send the excess current to the battery. In general, the slower the rpm becomes, the more the current will flow to the motor and increase the torque to bring the rpm back up to the design speed. This is done without a controller manipulating the electric motor. As such, this hybrid system can automatically manage the power and energy of the system without a controller. This leads to a less expensive and more reliable hybrid drive system. Moreover, with the addition of an engine, the vehicle may have an increased range. For example, the vehicle may be able to run off of the battery, the engine or a combination of both.

In some cases, the electric motor may be configured to act as a generator and recharge the battery. This may occur, for example, upon regenerative braking when excess inertia is translated into driveshaft motion, which in turn drives the motor and produces excess current. This current is transferred to the battery for recharging purposes. The engine may also be configured to power the motor. This may increase the torque going to the wheels, it may simply power the motor, or it may power the motor in such a manner that excess electricity is generated for recharging the battery. Thus, the engine may supplement the battery, or even be used to recharge the battery.

In this manner, a vehicle or other object may advantageously be driven by a controllerless hybrid system including a battery, a constant-speed motor, an engine, a clutch and a continuously variable transmission. The controllerless hybrid drive system is comparatively less expensive to build, may have high fuel- and energy-efficiency, and emits little or no pollution.

In some embodiments, as illustrated in FIG. 6, a computer 660 may be included as part of either or both of the controllerless electric drive system of FIG. 4 and the controllerless hybrid drive system of FIG. 5. Computer 660 may be configured to receive inputs from a user such as brake pedal 661 inputs and accelerator 662 inputs. In addition to user inputs, computer 660 may also receive inputs from sensors such as current sensor 663 which detects the amount of current flowing between the battery 610 and the motor 630 and rpm sensor 664. Using any one or a combination of these inputs, computer 660 may actively adjust the gearing of CVT 640 using actuator 665. The actuator increases or decreases the gear ratio as indicated by the computer. Accordingly, the torque to the wheels 650 is increases or decreases as the gear ratio in the CVT is adjusted.

Computer 660 may use actuator 665 to vary the rpm of the output shaft of the CVT, instead of varying the input rpm to a transmission. Thus, the input rpm (e.g. from a shunt DC or homopolar motor) to the transmission is not varied. In some embodiments, the CVT 640 has a mechanical lever that can be moved to change its gear ratio. This mechanical lever may be adjusted or actuated by a computer-controlled actuator 665 that is connected to the lever of the CVT. This, in turn, speeds lows down the rpm of the output shaft within preprogrammed parameters to allow smooth acceleration, deceleration, starting, and stopping.

In some cases, due to the nature of the electric motor implemented in the controllerless electric/hybrid drive system, the motor may be prone to abrupt starts and stops. Torque converter/clutch 635, in combination with a lower motor rpm provided by voltage changing switch 612, may be used to slowly accelerate the vehicle from idle to a certain speed. Additionally or alternatively, a computing device 660 may be implemented to receive inputs from a variety of sources and make determinations as to how the motor may be engaged or disengaged to the CVT to facilitate smooth acceleration and deceleration.

Input from the accelerator pedal may be used to determine that the degree to which the driver desires to accelerate. A high input value would indicate that quick acceleration is desired, and a low input value would indicate that a slower, more gradual acceleration is desired. Similarly, input from the brake pedal may indicate the degree to which the driver desires to decelerate. RPM and current sensors may indicate the current operating conditions of the battery, the motor and the CVT. These inputs may be used alone or in addition to the brake pedal and accelerator inputs to generate an output to the actuator 665 that is designed to provide the detected desired action (e.g. quick, slow or moderate acceleration or deceleration).

As described above, shunt and homopolar motors may be used (at least in part) to propel or provide the motive force for the vehicle. As the motors draw current from or allow current to flow back to the battery, a current sensor 663 may be used to monitor the current flow between the motor and the battery. The data detected by the sensor may be used by the computer to determine how much the motor is slowing or speeding up. Based on such data, the computer may determine that the rate of acceleration or deceleration is too great and control the rate accordingly by varying the CVT speed ratios using actuator 665. An rpm sensor 664 that monitors the rpm of the output shat of the CVT may similarly be used to detect acceleration or deceleration rates. This data may be used in addition to, or as an alternative to, the data provided by the current sensor mentioned above.

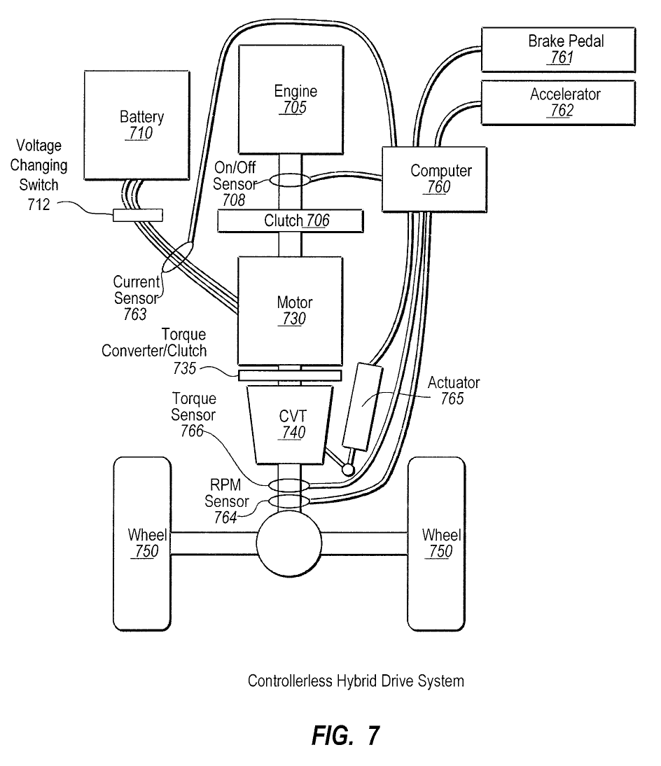

As illustrated in the controllerless hybrid drive system of FIG. 7, where an engine 705 is connected to the motor 730 via a clutch 706 to power the motor (thereby turning the CVT 740 (and hence, wheels 750) or charging the battery 710), an on/off sensor 708 may be used to monitor the on/off state of the engine or other operating conditions of the engine. Thus, data indicating how (or if) the engine is operating may be used to moderate application of the actuator 765, based on acceleration or deceleration inputs (e.g. 761, 762) provided by the driver, as well as inputs from other sensors (e.g. current sensor 763, torque sensor 766 and rpm sensor 764) in the drive system. Computer 760 can use these inputs to vary the driving characteristics of the car, including the rate of acceleration or deceleration. Moreover, as with FIGS. 4-6, a torque converter/clutch 735 may be used between motor 730 and CVT 740 to allow the motor to rotate freely during idle and then gradually apply the motor's torque to the CVT as the driver presses the gas pedal. Additionally, a voltage changing switch 712 may be used to reduce the voltage flowing from the battery 710 to the motor during idle and for a predetermined portion of initial vehicle acceleration.

The CVT controller can be used in a wide variety of configurations. In the configurations illustrated in FIGS. 6-10, each CVT has its own computer-controlled actuator. FIG. 6 shows a controllerless electric drive system, in which the CVT 640 sends output to a conventional differential. FIG. 7 shows a controllerless (parallel) hybrid drive system in which the CVT 740 sends output to a conventional differential.

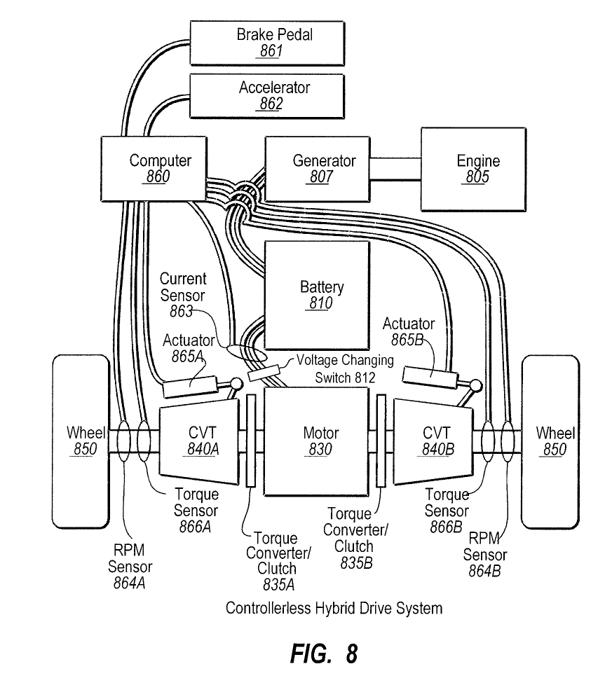

FIG. 8 shows a controllerless (serial) hybrid drive system with two CVTs (840A and 840B), one on each side of the motor 830 driving the wheels 850 individually. As in FIGS. 6 and 7, the controllerless hybrid drive system of FIG. 8 includes a computer 860 configured to receive user inputs from brake pedal 861 and accelerator 862, as well as sensor inputs from current sensor 863, torque sensors 866A and 866B and rpm sensors 864A and 864B. In this figure, each wheel is driven by a separate CVT and the gearing for each CVT is adjusted using separate actuators (865A and 865B, respectively). The engine 805 may be configured to power generator 807 which then charges battery 810 which provides the power for motor 830. The voltage to the battery may be limited by voltage changing switch 812. While motor 830 provides substantially the same amount of torque to CVTs 840A and 840B via torque converters/clutches 835A and 835B, respectively, each CVT may be individually and separately adjusted and may drive each wheel at a different speed using actuators 865A and 865B.

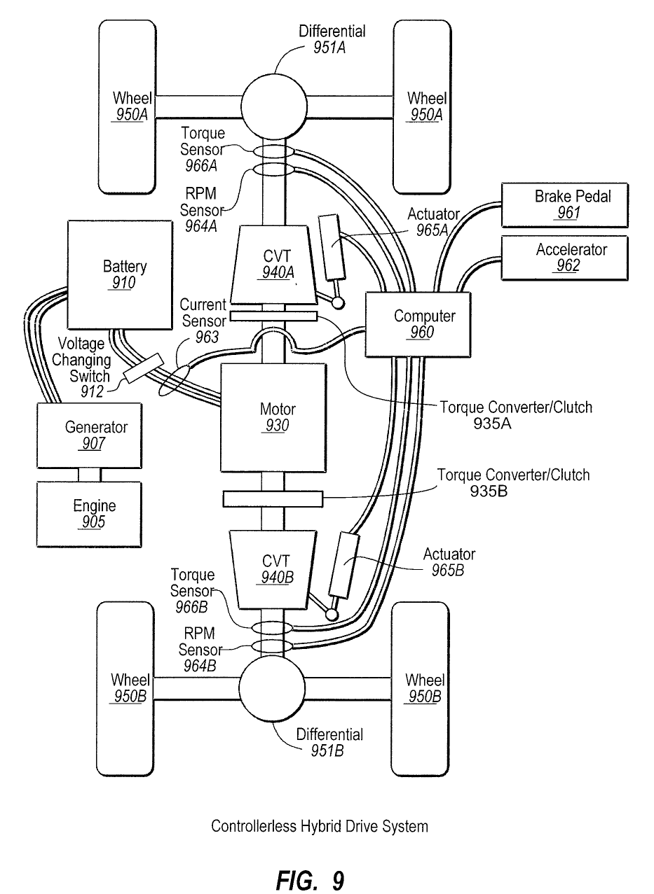

FIG. 9 shows a controllerless (serial) hybrid drive system with two CVTs (940A and 940B), one on each side of the motor 930, each driving a different set of wheels (950A and 950B, respectively). Like the drive system of FIG. 8, the controllerless hybrid drive system of FIG. 9 includes an engine 905 that powers a generator 907 which charges the battery 910. The battery, in turn, provides power for motor 930 which drives the two CVTs via torque converters/clutches 935A and 935B, respectively. The battery's voltage may be limited by voltage changing switch 912. The gearing for CVT 940A is adjusted by actuator 965A and the gearing for CVT 940B is adjusted by actuator 965B. Each actuator is individually adjustable, depending on inputs received from the user (e.g. brake pedal 961 and accelerator 962) and from rpm sensors 964A and 964B, torque sensors 966A and 966B and current sensor 963. Accordingly, the wheels 950A attached to differential 951A and driven by CVT 940A may be driven at a different speed or acceleration/deceleration rate than wheels 950B which are attached to differential 951B driven by CVT 940B. Computer 960 may make continual decisions as the car is being driven as to how the speed should be adjusted for each set of wheels by appropriately adjusting the gearing of the corresponding CVT using its actuator.

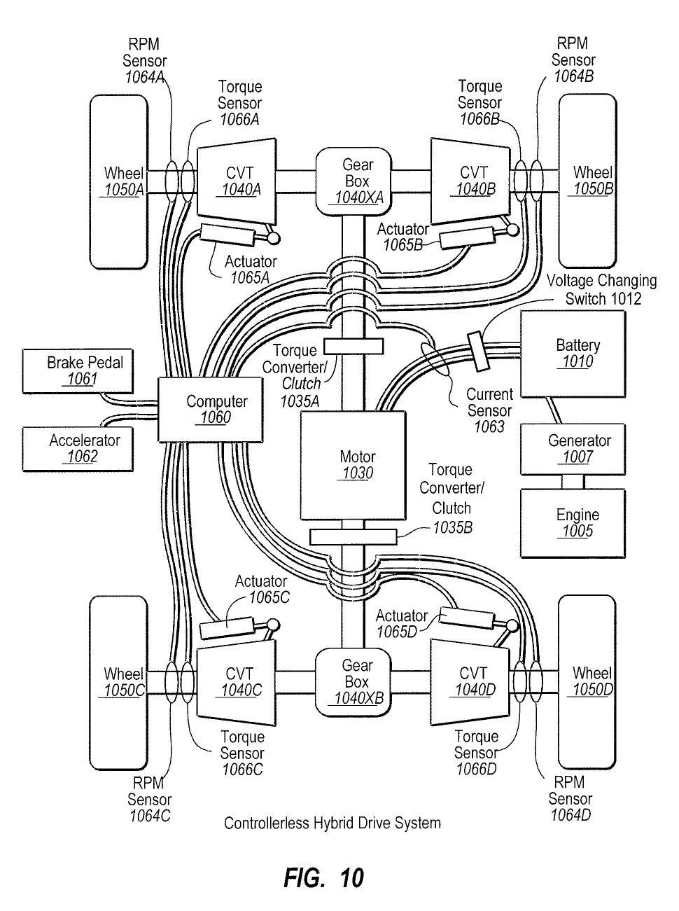

FIG. 10 illustrates a controllerless electric drive system with four CVTs (1040A-D), one for each wheel (1050A-D, respectively). Like the drive system of FIG. 9, the controllerless hybrid drive system of FIG. 10 includes a computer module 1060 configured to receive inputs from the user (e.g. from brake pedal 1061 and/or from accelerator 1062) as well as from various sensors including rpm sensors 1064A-D and torque sensors 1066A-D, placed at wheels 1050A-D, respectively, and from current sensor 1063. The computer can separately and dynamically adjust the gearing on each of the CVTs 1040A-D based on the received inputs using corresponding actuators 1065A-D. The drive system of FIG. 10 also includes an engine 1005 which powers generator 1007 which charges battery 1010. The battery's voltage flow to the motor may be limited by voltage changing switch 1012. The battery drives the motor 1030 (e.g. DC shunt motor or homopolar motor) which, in turn, drives the gear boxes 1040XA and 1040XB via torque converters/clutches 1035A and 1035B, respectively. The gear boxes transfer power to the CVTs, which vary the torque to the driven wheels as directed by the actuators 1065A-D.

Many other configurations and combinations are possible. For example, in some embodiments, each CVT may have a separate computer module (e.g. 1060). In some embodiments, each of these computer modules may receive inputs from one or more of the aforementioned input sources. Such configurations may allow a driver to run the wheels in various manners, including running the wheels on one side forward and the wheels on the other side in reverse, thus allowing the vehicle to turn or spin on the spot.

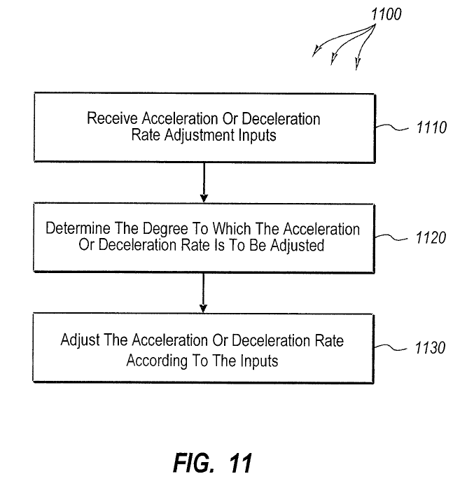

FIG. 11 illustrates a flowchart of a method 1100 for controlling drive system characteristics based on one or more received drive system inputs. The method 1100 will now be described with frequent reference to the components and data of FIGS. 4-10.

Method 1100 includes an act of receiving one or more inputs from a vehicle user indicating that at least one of an acceleration rate and a deceleration rate is to be adjusted, the acceleration and deceleration rates being adjustable using at least one of a voltage changing switch to change the voltage flowing from the battery to the motor and an actuator configured to vary the rpm of the output shaft of the CVT (act 1110). For example, computer module 660 may receive brake pedal 661 input, accelerator 662 input or other inputs from a user indicating that the rate of acceleration or deceleration is to be adjusted. As explained above, the acceleration and deceleration rates may be adjusted at the CVT 640 using actuator 665 which is configured to vary the rpm of the output shaft of the CVT. Additionally or alternatively, the acceleration and deceleration rates may be adjusted using voltage changing switch 612 to change the voltage flowing from the battery 610 to the motor 630. Thus, while the motor 630 is, at least in some cases, a constant-speed (DC shunt or homopolar motor) motor, torque to the wheels 650 is adjustable using the adjustable gear ratios of the CVT.

Method 1100 also includes an act of determining, based on the received inputs, the degree to which the acceleration rate or the deceleration rate is to be adjusted (act 1120). For example, based on inputs received from accelerator 662, the computer can determine that acceleration is to be increased or decreased and the rate at which the acceleration should be increased or decreased. Similarly, inputs received from the brake pedal 661 may indicate regenerative braking is to be applied and hence, that the CVT is to engage wheels such that the wheels drive the CVT which can, in turn, provide the excess torque to the motor which can recharge the battery 910. In some cases, the constant-speed electric motor is configured to automatically begin charging the battery upon determining that a threshold level of excess torque is available from the CVT.

In some embodiments involving a controllerless hybrid drive system such as the one illustrated in FIG. 7, the engine 705 may not be engaged to assist the battery 710 in powering the motor 730 until the system detects that additional torque beyond a threshold value has been requested. In some cases, the drive system may further include a monitoring system to monitor the state of charge for the battery, such that when the battery 710 is fully charged, the clutch 706 is disengaged and the engine 705 is turned off. Additionally or alternatively, the engine may be automatically started and the clutch may be automatically engaged when the monitoring system indicates that the battery is below a threshold charge value.

Returning to FIG. 11, method 1100 also includes an act of adjusting at least one of the acceleration rate and the deceleration rate by varying the rpm of the output shaft of the CVT using the actuator (act 1130). For example, computer 660 may adjust the acceleration or the deceleration rate by performing at least one of the following: changing the voltage flowing from the battery to the motor using the voltage changing switch and varying the rpm of the output shaft of the CVT 640 using actuator 665. Accordingly, the wheels will be accelerated or decelerated at an appropriate rate, based on the inputs received at the computer.

In some embodiments, the computer modules may allow a user to program various options or settings relating to the drive system. For example, the drive system may be programmed to perform at different levels, from high-powered muscle car type performance to underpowered, fuel-conserving performance, and may be reprogrammable or changeable on the fly. These different drive system characteristic models may allow a parent to program the system to limit the vehicle's performance while his or her children or other drivers are driving, and reprogram (or simply change the program settings) to enable the vehicle's full performance capacity when the parent is driving. Other performance settings may also be programmed or configured by the user. In some cases, a user may program the vehicle's drive system settings to his or her liking, save them to a storage medium, and publish them to other users for use on their own cars. Thus, a computer module may be used to manage and alter vehicle characteristics including acceleration- and deceleration-based on inputs from the user.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. In an automotive system comprising one or more powered wheels, a controllerless electric drive system configured to power the one or more powered wheels, the system comprising:
a battery;
a substantially constant-speed electric motor;
a torque converter;
a continuously variable transmission; and
one or more powered wheels, wherein the battery is coupled to the substantially constant-speed electric motor, and wherein the substantially constant-speed electric motor is coupled to the continuously variable transmission via the torque converter, such that the battery provides power for the electric motor to drive the continuously variable transmission which turns the one or more powered wheels, without implementing a controller to vary the current between the battery and the motor.

2. The controllerless electric drive system of claim 1, wherein the substantially constant-speed electric motor comprises a shunt motor.

3. The controllerless electric drive system of claim 1, wherein the substantially constant-speed electric motor comprises a homopolar motor.

4. The controllerless electric drive system of claim 1, wherein the continuously variable transmission coupled to the torque converter is configured to increase and/or decrease drive power to the driven wheels while the substantially constant-speed electric motor runs at a substantially constant speed.

5. The controllerless electric drive system of claim 4, wherein drive power to the driven wheels is increased or decreased by varying the output shaft speed of the CVT according to one or more received inputs.

6. The controllerless electric drive system of claim 5, wherein the received inputs are received from at least one of an accelerator pedal, a brake pedal, a current sensor that monitors current flow between the battery and the motor, an rpm sensor which monitors the rpm of the output shaft of the CVT, a sensor coupled to an engine configured to monitor the engine's on/off status, and a torque sensor which monitors the torque of the output shaft of the CVT.

7. The controllerless electric drive system of claim 1, further comprising a voltage changing switch configured to reduce the amount of voltage flowing from the battery to the motor.

8. A controllerless hybrid drive system comprising:
a battery;
a substantially constant-speed electric motor;
an engine;
a first clutch positioned between the engine and the electric motor;
a continuously variable transmission;
a second clutch positioned between the electric motor and the continuously variable transmission; and
one or more powered wheels, wherein the battery is coupled to the substantially constant-speed electric motor, wherein the engine is coupled to the motor through the first clutch, and wherein the substantially constant-speed electric motor is coupled to the continuously variable transmission via the second clutch, such that both the battery and the engine provide power for the electric motor to drive the continuously variable transmission which turns the one or more powered wheels, without implementing a controller to vary the current and voltage between the battery and the motor.

9. The controllerless hybrid drive system of claim 8, wherein the substantially constant-speed electric motor comprises a shunt motor.

10. The controllerless hybrid drive system of claim 8, wherein the substantially constant-speed electric motor comprises a homopolar motor.

11. The controllerless hybrid drive system of claim 8, wherein the engine is not engaged to assist the battery in powering the motor until the system detects that additional torque beyond a threshold value has been requested.

12. The controllerless hybrid drive system of claim 8, further comprising a monitoring system to monitor the state of charge for the battery, such that when the battery is fully charged, the first clutch is disengaged and the engine is turned off.

13. The controllerless hybrid drive system of claim 8, further comprising a voltage changing switch configured to reduce the amount of voltage flowing from the battery to the motor.

14. The controllerless hybrid drive system of claim 8, wherein the substantially constant-speed electric motor is configured to charge the battery upon determining that a threshold level of excess torque is available.

15. At a computing device, a method for controlling drive system characteristics based on one or more received drive system inputs, the drive system including at least a battery, a motor and a continuously variable transmission (CVT), the method comprising:
an act of receiving one or more inputs from a vehicle user indicating that at least one of an acceleration rate and a deceleration rate is to be adjusted, the acceleration and deceleration rates being adjustable using at least one of a voltage changing switch to change the voltage flowing from the battery to the motor and an actuator configured to vary the rpm of the output shaft of the CVT;
an act of determining, based on the received inputs, the degree to which the acceleration rate or the deceleration rate is to be adjusted; and
an act of adjusting at least one of the acceleration rate and the deceleration rate by performing at least one of the following: changing the voltage flowing from the battery to the motor using the voltage changing switch and varying the rpm of the output shaft of the CVT using the actuator.

16. The method of claim 15, wherein the drive system is a controllerless hybrid drive system.

17. The method of claim 15, wherein the drive system is a controllerless electric drive system.

18. The method of claim 15, wherein the inputs are received from at least one of an accelerator pedal, a brake pedal, a current sensor that monitors current flow between the battery and the motor, an rpm sensor which monitors the rpm of the output shaft of the CVT, a torque sensor which monitors the torque of the output shaft of the CVT, and a sensor coupled to an engine configured to monitor the engine's on/off status.

19. The method of claim 15, wherein one or more of the drive system characteristics are user programmable.

20. The method of claim 19, wherein the user applies a drive system characteristics model to the drive system, such that each of the drive system characteristics complies with the characteristics defined in the model.
